(19) United States
(12) Patent Application Publication
(10) Pub. No.: US 2015/0188883 A1
(43) Pub. Date: Jul. 2, 2015

(54) METHOD AND SERVICE SYSTEM FOR IMPLEMENTING DOMAIN NAME REGISTRATION AND RESOLUTION BASED ON DOMAIN NAME GROUP

(71) Applicant: Computer Network Information Center, Chinese Academy of Sciences, Beijing (CN)

(72) Inventors: Jiagui Xie, Beijing (CN); Hongtao Li, Beijing (CN); Weiping Yang, Beijing (CN); Chao Qi, Beijing (CN)

(73) Assignee: Computer Network Information Center, Chinese Academy of Sciences, Beijing (CN)

(21) Appl. No.: 14/416,635

(22) PCT Filed: Dec. 20, 2012
(86) PCT No.: PCT/CN2012/087061

§ 371 Date: Jan. 23, 2015

(30) Foreign Application Priority Data
Dec. 10, 2011 (CN) 201210531719.9

(51) Int. Cl. H04L 29/12

(52) U.S. Cl. CPC H04L 61/302; H04L 61/10

(57) ABSTRACT

The disclosed method and system implement domain name registration and resolution based on a domain name group. The system comprises a registration client terminal, a registration server, and a resolution server. The registration server processes single domain name registration information and generates a unique identification for domain name group information, stores the domain name group information and stores registrant information and resolution information associated with the domain names, and feeds back a processing result to the registration client terminal. The resolution server acquires the domain names in the domain name group and resolution data shared by the domain names, and writes the domain names and the resolution data into resolution files according to top-level domain suffixes. The present invention can bind, register and resolve domain names, ensures that the bound domain names belong to the same registrant, and facilitates registration, resolution and subsequent processing of the domain names.

### BACKGROUND OF THE INVENTION

The present invention relates to the field of computer network, in particular, to a method and a service system for implementing domain name registration and resolution based on a domain name group.

Domain Name, composed of a string of names separated by dots, is the name of a computer or a computer group in Internet. It is used to identify computer's electronic location (sometimes the geographical location) in data transmission. At present, the domain name has become a brand name on the Internet, and need to be protected by online trademarks.

After 20 years of development, especially with the generation of internationalized domain name (IDN), great changes have taken place in the domain name industry. Traditional registration and analytical methods can no longer meet the current needs for domain name registrations and resolutions.

As a simple example: Chinese characters include simplified, traditional, and variant character types; thus Chinese domain name registrations need to make sure that the domain names of simplified, traditional, and variant Chinese characters to be registered to the same registrant. But under the current registration policies, only one domain name can be registered each time, which means that domain names of the simplified, traditional, and variant Chinese characters must be registered separately in many times. The registrations involve users to enter repetitive information many times, and the registration and services agencies to storage duplicate information. The traditional registration method clearly cannot conveniently meet the current registration needs. Furthermore, a different strategy needs to be adopted from the traditional method for the domain name resolutions of simplified, traditional, and variant Chinese characters. The traditional registration method is not only complex, but also error prune, and not convenient for unified management.

### SUMMARY OF THE INVENTION

To overcome the above described problems, the present invention provides a method and a service system for binding domain names in registrations and resolutions based on the “domain name group” concept proposed herein. When a user registers a domain name, the disclosed method allows the user to create, at the same, different versions of domain names in simplified, traditional, and variant Chinese characters, or to create another domain name which has same meaning of the registered domain name. These domain names share registration information such as the registrant. The disclosed method supports convenient registration and resolution of multiple domain names. Thus bound registered domain names belong to a same registrant. Moreover, the disclosed method can implement generation, resolution, and editing of groups of domain names based on user settings or policies supported by the registration institution, and can also connect seamlessly with the existing DNS systems.

The so-called domain name group refers to an entity that consists of one or more domain names. These domain names share information such as registrant and contacts. If the shared attributes are modified, the related information of all domain names within the group will be changed. The domain names within a domain name group can include related simplified, traditional, and variant versions of Chinese characters, which correspond to each other (for example, HuQingYuTang.China respectfully in simplified and traditional Chinese characters), as well as corresponding domains in Chinese characters and English letters (such as color.cn andyanse.cn in Chinese characters), or domain names with no relationship (such as a.cn and a.zhongguo in Chinese character). In general, the domain names of different top-level domains, must be managed in the same registration institution). The disclosed method can create, renew, transfer, delete, and modify domain name groups, and can also separately conduct these operations for individual domain names in a domain name group.

The method for implementing domain name registration and resolution based on a domain name group, provided by the present invention, the process is as follows:

(1) receiving registration information of a domain name or a domain name group from a registration client terminal, wherein the domain name group includes a plurality of domain names sharing common attributes;

The registration of a domain name or a domain name group can include the following steps:

(i) receiving the registration information by a registration server from the registration client terminal, wherein the registration information is related to the single domain name or the domain name group (the registration information can for example include: a domain name, a registrant of the domain name, a technical contact of the domain name, a account contact of the domain name, resolution data of the domain name, and so on);

(ii) determining, by the registration server, whether the registration information contains information about a domain name group; if so, turning to step iii), otherwise turning to step iv);

(iii) if the domain name application contains information about a domain name group, generating, by the registration server, a unique identification for the information related to the domain name group; storing the information related to the domain name group; and storing registrant information and resolution information shared by the domain names the domain name group in association with the unique identification (the algorithm for generating the unique identification can be incremental digital, also can be date and so on, as long as it is kept unique);

(iv) processing registration of the single domain name by the registration server; turning to step v);

(v) checking by the registration server whether the domain name or the domain name group has been successfully set up; and feeding back a processing result to the registration client terminal.

(2) The resolution server acquires, according to the unique identifications of the domain names, all the domain names in the domain name group and resolution data shared by the domain names, and writes the domain names and the resolution data into resolution files according to top-level domain suffixes respectively.

The presently disclosed method for implementing domain name registration and resolution based on a domain name group can also include editing operations such as additions and deletions of one or more domain names in the domain name group, comprising the steps of:

(1) receiving changes to the one or more domain names from the registration client terminal (such as the registrant of a domain name, the technical contact of a domain name, the account contact of a domain name, and the addition or deletion of one or more domain names within the domain name group);

(2) determining by a registry or a registration service provider if the change contains additions or deletions of one or more domain names in the domain name group (in the modified data, if the addition or deletion fields contain domain names then it is determined to include the operation), if yes, turn to step (3), or turn to step (4);

(3) if the change includes deletion of one or more domain names from the domain name group, deleting the one or more domain name(s) in the domain name field(s) and in the unique identification associated with the domain name group; if the change includes addition of one or more domain names to the domain name group, adding a record of the one or more domain names to the domain name group and the unique identification associated with the domain name group, and turning to step (4);

(4) finding the unique identification associated with the domain name; and finding shared attributes of the domain name group using the unique identification; updating the domain name group according to the change submitted by the registration client terminal, determining if the update is successful; if successful, turning to step (5), if not successful, turning to step (6);

(5) transmitting a message about a successful update from the registration server to the registration client terminal; turning to step (7);

(6) transmitting a message about a failed registration from the registration server to the registration client terminal;

(7) determining if the one or more domain names are added to or deleted from in the domain name group, acquiring a unique identification related to the added or deleted one or more domain names by the resolution server; acquiring resolution data shared by the domain names using the unique identification; and adding the one or more domain names into the resolution file or deleting the one or more domain names from the resolution file according to top-level domain suffix of the domain name.

One of the features of the present invention is editing for a domain name group as a whole, including, but not limited to, transfer, renewal, deletion of one or more domain names in the domain name group, which can includes the steps as follows:

(1) receiving a change (transfer, renew, delete, etc.) to the domain name group from the registration client terminal;

(2) determining whether the change is related to a domain name group (querying whether there are more than one the unique identification in the registration information; and if there are more than one unique identification, concluding that the registration information is to be processed with the domain name group); if it is, turning to step (3), or turning to step (4);

(3) querying a unique identification of the domain name group related to the change; using the unique identification to query shared attributes of the domain names in the domain name group and registrar information in the shared attributes; turning to step (4);

(4) editing the domain name; and transmitting an editing result to the registration client terminal;

(5) determining if a domain name is to be deleted;

(6) acquiring, by the resolution server, the unique identification the unique identification associated with the domain name to be deleted, and using the unique identification to acquire resolution data shared by the domain names and number of domain names in the domain name group; deleting resolution records of the domain name from a resolution file of the domain name group according to top-level domain suffixes.

The present invention also provides a service system for implementing domain name registration and resolution based on a domain name group. The system comprises a registration client terminal, a registration server, and a resolution server. The registration client terminal the registration client terminal is configured to record information related to domain names, and to transmit the information to the registration server. The registration server can process registration of a single domain name or to generate a unique identification for a domain name group, to store information related to the domain name group separately, to store registrant information and resolution information associated with the domain names according to the unique identification, and to feed back a processing result to the registration client terminal. The resolution server can be connected to the registration server and is configured to acquire all domain names in the domain name group and resolution data shared by the domain names according to the unique identifications, and to write the domain names and the associated resolution data into resolution files according to top-level domain suffixes respectively.

The present invention has lower deployment cost than conventional methods, and can bind domain names in a group for their registrations and resolutions. The disclosed system and methods can ensure that the bound domain names belong to the same registrant, and facilitate registrations, resolutions, and subsequent processing of the domain names.

### BRIEF DESCRIPTION OF THE DRAWINGS

FIG. 1 is a schematic system diagram for a domain-name registration and resolution system that supports registrations of domain name groups.

FIG. 2 is a flowchart for creating one or a group of domain names.

FIG. 3 is a flowchart for updating a group of domain names.

FIG. 4 is a flowchart of logic operation in accordance with the present invention.

### DETAILED DESCRIPTION OF THE INVENTION

The following is further description of the present invention referring to the appended drawings, but not to limit the present invention.

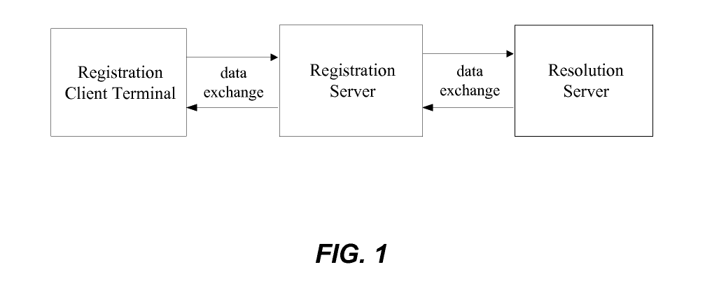

FIG. 1 is schematic diagram of a registration and resolution system that supports registration of a group of domain names (i.e. the domain name group). A registrant uses a registration client terminal to register one or more domain names. The registration client terminal and a registration server can be deployed in the same host, and also can be deployed on different hosts. The registration client terminal and the registration server interact through the formatted data, to provide standard registration services for registrants. In addition, the registration server interacts with a resolution server through exchange of domain name data, to achieve resolution of the domain name group.

In registering domain names, users can create a “domain name group” based on their own requirements. Once created, the domain names in a domain name group share common attributes (including but not limited to the registrant information, resolution information, etc.), users can do batch operations on the domain names in the domain name group.

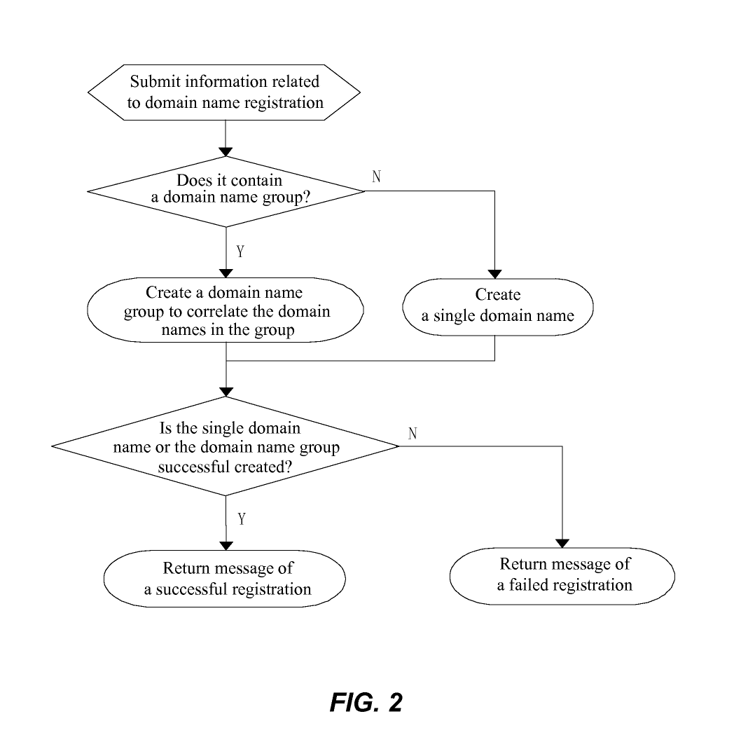

FIG. 2 is a flowchart for creating one or a group of domain names, including the following detailed steps:

1) The registration client terminal submits information related to domain name registration (for example, a domain name, a registrant of the domain name, a technical contact of the domain name, an account contact of the domain name, resolution data of the domain name, etc.);

2) A registry or a registration service agency determines whether the registration information from the register client terminal involves a domain name group (i.e. whether the registration information contains two or more domain names); if so, turning to step 3), otherwise, turning to step 4).

3) A unique identification is generated for the domain name group (the algorithm of the identification can be incremental digital, also can be date, etc., as long as it is kept unique). Information about the domain name group is stored separately, and the registrant and resolution information associated with the domain names are stored according to the unique identification, with an example shown in table 1:

TABLE 1

| Domain name | Unique identification | Registrant | Resolution data |
|---|---|---|---|
| a.cn | bundle0000000001 | abc | ns.a.cn |
| b.cn | | | |
| c.cn | bundle0000000002 | def | ns.c.cn |
| d.cn | | | |

It can be seen from table 1 that a.cn and b.cn belong to a same domain name group; c.cn and d.cn belong to another domain name group. Domain names in each domain name group have shared attributes and a same unique identification. The domain names in a domain name group can be obtained using the unique identification; turning to step 5);

4) The registration information for the single domain name is processed; turning to step 5);

5) It is determined whether the domain name creation by the registration server is successful; If so, turning to step 6); otherwise, turning to step 7);

6) The registration server returns a message about a successful registration to the registration client terminal, turning to step 8);

7) The registration server transmits a message about a failed registration to the registration client terminal.

Next, the resolution server acquires all the domain names and acquires resolution data shared by the domain names in the domain name group according to the unique identification, and writes them into resolution files respectively according to top-level domain suffixes (for example: the top-level domain suffix of a.cn is cn, the top-level domain suffix of a.com is com), which implements resolution for the domain name group.

The following example is provided to more clearly illustrate the above described process. But it should be noted that the present invention is not limited this or other examples in the present disclosure.

1) The registration client terminal sends issues a command to create domain names, the command including the following registration information:
a.cn
b.cn
Registrant: Zhang San
Technical contact: Li Si
Registrar: abc
Domain name resolution server: ns.a.cn

2) The registration server receives the registration information from the registration client terminal, and determines that the registration operation relates to the creation of a domain name group, wherein the domain names in the domain name group are: HuQingYuTan.zhongguo (in standard Chinese characters) and HuQingYuTan.cn (in a variant type of Chinese characters);

The two domain names share common attributes of the registrant, the technical contact, and the registrar;

A unique identification is generated for the domain name group by the registration server: bundle000000000001;

3) The information about the domain name group is written into database:

| Domain name | Domain name identification |
|---|---|
| a.cn | bundle000000000001 |
| b.cn | bundle000000000001 |
| Unique identification | bundle000000000001 |
| Registrant | Zhang San |
| Technical contact | Li Si |
| Registrar | abc |
| Domain name resolution server | ns.a.cn |

4) A message about the success of the domain name registration is returned to the registration client terminal, which accomplished the registration of the domain name group;

5) The resolution server implements resolution of the domain name group:

Based on the unique identifications of the domain names, the resolution server acquires all the domain names and resolution data shared by the domain names in the domain name group. The resolution server writes the domain names and the resolution data respectively into resolution files according to top-level domain suffixes, and implements resolution of the domain name group.

Take a.cn for example, the unique identification of a.cn is: bundle0000000001;

Acquiring all the domain names in the domain name group based on the unique identification: a.cn and b.cn;

And acquiring resolution data shared by the domain names: ns.a.cn;

Based on the top-level domain suffixes (in this example they are all cn), writing into different resolution files respectively: the suffixes are the same in this example, so writing into the same resolution file, and adding resolution records into the same resolution file as follows:

| | | |
|---|---|---|
| a.cn | NS | ns.a.cn |
| ns.a.cn | A | 1.1.1.1 |
| b.cn | NS | ns.a.cn |

When domain names are updated, users can update the contact and resolution information, etc. of the domain names as well as setting up new domain name group(s). The update operation allows users to add or delete one or more domain name within a domain name group.

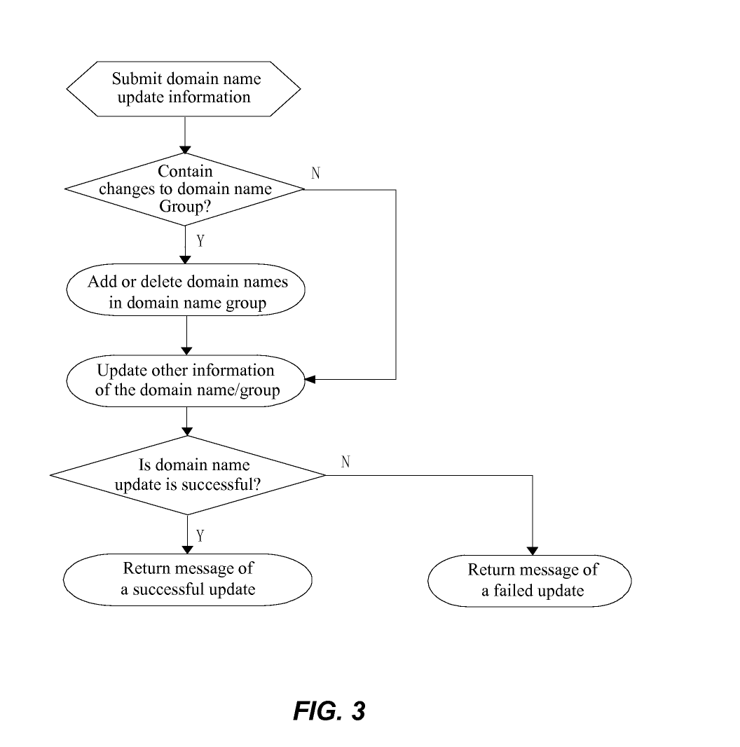

FIG. 3 is a flowchart for updating a group of domain names, as described below:

(1) The registration client terminal submits information related to domain name changes (such as changes in the registrant, the technical contact, the account contact of a domain name, or addition or deletion of one or more domain names in a domain name group);

(2) The registry or a registration service provider determines if additions or deletions of domain names in domain name group are included in the submitted change information (which depends on whether the formatted information for domain name change includes domain names in addition or deletion fields). If so, turning to step (3), if not included, turning to step (4);

(3) If a domain name is to be deleted from a domain name group, the domain name is directly deleted from the domain name field and from the unique identification. If a domain name data is to be added to the domain name group, the domain name is added to the domain fields and in the unique identification (for example: the logic of adding e.cn into the domain name group a.cn involves: first find the unique identification of the domain name group through a.cn: bundle0000000001; then respectively add records e.cn bundle0000000001 into the fields of domain name and the unique identification), turn to step (4);

(4) Using the domain name to find the unique identification of the domain name (for example: the unique identification of a.cn is found to be: bundle0000000001); and using the unique identification to find shared attributes of the domain name group:

| unique identification | registrant | resolution data |
|---|---|---|
| bundle0000000001 | abc | ns.a.cn |

Then using the information about the domain name change received from the registration client terminal to modify the fields in the registration data; determining if the update or modification is successful; if so, turning to step (5); if not, turning to step (6);

(5) The registration server returns a message of successful modification to the registration client terminal, turn to step (7);

(6) The registration server returns a message of failed modification to the registration client terminal;

(7) Determining whether the update or modification includes adding domain names into domain name group. If so, turning to step 8); otherwise turning to step 9);

(8) The resolution server acquires the unique identification based on the added domain name, and acquires resolution data shared by the domain names according to the unique identification. The resolution server writes the data into resolution files according to top-level domain suffixes (for example: the top-level domain suffix of a.cn is cn, the top-level domain suffix of a.com is com), thus accomplishing the resolution for updating the domain name group. (the example of adding b.cn into the domain name group a.cn includes the steps of: acquiring the unique identification of the domain name: bundle0000000001; acquiring the resolution data shared by the domain name group according to the unique identification: ns.a.cn; and updating the resolution files according to the top-level domain suffix of the domain name, in this example the suffix is cn, thus a new record is added the cn field:

| | | |
|---|---|---|
| b.cn | NS | ns.a.cn) |

(9) The resolution server acquires the unique identification based on the deleted domain name, and acquires resolution data shared by the domain names according to the unique identification. The resolution server deletes the domain name from resolution files according to top-level domain suffixes (for example: the top-level domain suffix of a.cn is cn, the top-level domain suffix of a.com is com), thus accomplishing the resolution of updating the domain name group. (The example of deleting b.cn from the domain name group a.cn includes the steps of: acquiring the unique identification of the domain name: bundle0000000001; acquiring the resolution data shared by the domain name group based on the unique identification: ns.a.cn; and updating the resolution files according to the top-level domain suffix of the domain name, in this example the suffix is cn, thus the record below is deleted from the cn fields:

| | | |
|---|---|---|
| b.cn | NS | ns.a.cn) |

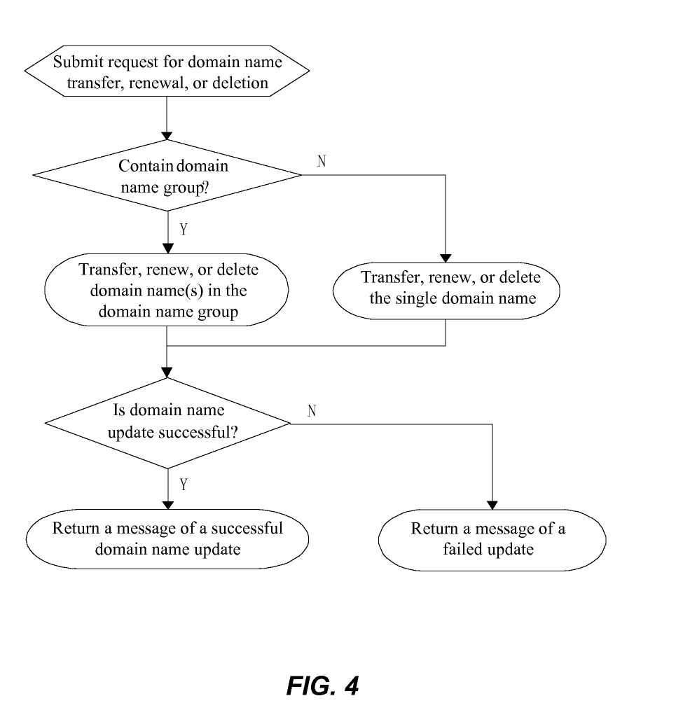

When domain names transferred, renewed, deleted, or updated, if the domain names belong to one domain name group, the domain names in the domain name group can be edited together in a joint operation (the corresponding logic operation flowchart is shown in FIG. 4):

(1) The registration client terminal submits information related to an update to a domain name group (e.g. transfer, renewal, deletion, etc.);

(2) The registration server determines whether the update or change relates to a domain name group (the judgment logic is: in the domain-name update information transmitted from the registration client terminal, query whether there is more than one record in the data field for unique identification; if so, it is determined that the update operation is for a domain name group); if so, turning to step (3); otherwise, turning to step (4);

(3) In the domain-name update information transmitted from the registration client terminal, querying the corresponding unique identification of the domain name group, and then based on the unique identification, querying the shared content of the domain name, as shown in the example below:

| Unique identification | Registrant | Resolution data |
|---|---|---|
| bundle0000000001 | abc | ns.a.cn |

modifying the registrar information in the shared attributes; turning to step (4);

(4) Updating the domain name (transfer, renewal, deletion, etc.), and determining if it is successful, if successful then turn to step 5), otherwise turn to step 6);

(5) The registration server transmits a message to the registration client terminal about a successful domain-name update;

(6) The registration server transmits a message to the registration client terminal about a failed domain-name update;

(7) Determining whether the domain-name update involves a deletion of domain name; if it does, turning to step (8); otherwise, exit the process;

(8) The resolution server acquires the unique identification according to the domain names to be deleted, and acquires resolution data shared by the domain name based on the unique identification, as well as the quantity of domain names in the domain name group. The resolution server deletes the resolution record of the domain name from the resolution files respectively according to top-level domain suffixes (for example: the top-level domain suffix of a.cn is cn, the top-level domain suffix of a.com is com), thus accomplishing deletion resolution to the domain name group. (In an example of the domain name group a.cn, when a domain name is to be deleted, the resolution server acquires the unique identification of the domain name group: bundle0000000001, and then acquire the resolution data shared by the domain name group according to the unique identification: ns.a.cn. Another domain name in the domain name group is b.cn. The resolution record is deleted from resolution files according to the top-level domain suffix of the domain name. In this example, the suffixes are cn, so the record below deleted respectively from the cn data fields:

| | | |
|---|---|---|
| a.cn | NS | ns.a.cn |
| ns.a.cn | A | 1.1.1.1 |
| b.cn | NS | ns.a.cn |

Although the present invention is disclosed as above, it is not used to limit the present invention, any technical personnel of the technical field, within the spirit and scope of the present invention, can make arbitrary changes or equivalent replacement, so the protection scope of the present invention should be the scope defined by the claims of this application.

While this document contains many specifics, these should not be construed as limitations on the scope of an invention that is claimed or of what can be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or a variation of a sub-combination.

What is claimed is:

1. A method for implementing domain name registration and resolution based on a domain name group, comprising the steps of:
(1) receiving registration information of a single domain name or a domain name group from a registration client terminal, wherein the domain name group includes a plurality of domain names sharing common attributes; and
(2) acquiring, by a resolution server, according to the unique identifications of the domain name group, all the domain names in the domain name group and resolution data shared by the domain names; and writing the domain names and the resolution data into resolution files according to top-level domain suffixes respectively,
wherein the step of registering a single domain name or a domain name group comprises the following steps:
(i) receiving the registration information by a registration server from the registration client terminal, wherein the registration information is related to the single domain name or the domain name group;
(ii) determining, by the registration server, whether the registration information contains information about a domain name group;
(iii) if the domain name application contains information about a domain name group, generating, by the registration server, a unique identification for the information related to the domain name group; storing the information related to the domain name group; and storing registrant information and resolution information shared by the domain names the domain name group in association with the unique identification;
(iv) processing registration of the single domain name by the registration server; and
(v) if the domain name application does not contain information about a domain name group, checking by the registration server whether the domain name or the domain name group has been successfully set up; and feeding back a processing result to the registration client terminal.

2. The method of claim 1, wherein the registration information related to a single domain name includes a domain name, a registrant of the domain name, a technical contact of the domain name, an account contact of the domain name, and resolution data of the domain name.

3. The method of claim 1, wherein the unique identification is algorithmically obtained by incrementing numbers and dates.

4. The method of claim 1, further comprising:
editing one or more domain names after the steps of registering and acquiring, comprising the steps of:
(1) receiving changes to the one or more domain names from the registration client terminal;
(2) determining by a registry or a registration service provider if the change contains additions or deletions of one or more domain names in the domain name group;
(3) if the change includes deletion of one or more domain names from the domain name group, deleting the one or more domain name(s) from domain name fields and in the unique identification associated with the domain name group;
if the change includes addition of one or more domain names to the domain name group, adding a record of the one or more domain names to the domain name group and the unique identification associated with the domain name group;
(4) finding the unique identification associated with the domain name; and finding shared attributes of the domain name group using the unique identification; updating the domain name group according to the change submitted by the registration client terminal, determining if the update is successful;
(5) if the update to the domain name group is successful, transmitting a message about a successful update from the registration server to the registration client terminal;
(6) if the update to the domain name group is not successful, transmitting a message about a failed update from the registration server to the registration client terminal; and
(7) determining if the one or more domain names are added to or deleted from in the domain name group, acquiring a unique identification related to the added or deleted one or more domain names by the resolution server; acquiring resolution data shared by the domain names using the unique identification; and adding the one or more domain names into the resolution file or deleting the one or more domain names from the resolution file according to top-level domain suffix of the domain name.

5. The method of claim 4, wherein the registration information related to the one or more domain names to be added or deleted includes a registrant of a domain name, a technical contact of the domain name, an account contact of the domain name, and information about the domain name group that the domain name is associated with.

6. The method of claim 1, further comprising:
editing the domain name group as a whole after the steps of registering and acquiring, comprising the steps of:
(1) receiving a change to the domain name group from the registration client terminal;
(2) determining whether the change is related to a domain name group;
(3) if the change is related to the domain name group, querying a unique identification of the domain name group related to the change; using the unique identification to query shared attributes of the domain names in the domain name group and registrar information in the shared attributes; and
(4) if the change is not related to the domain name group, editing the domain name; and
transmitting an editing result to the registration client terminal.

7. The method of claim 6, wherein the change includes transfer, renewal, or deletion of the domain name.

8. The method of claim 6, wherein the step of determining comprises:
querying whether there are more than one the unique identification in the registration information; and
if there are more than one unique identification, concluding that the registration information is to be processed with the domain name group.

9. The method of claim 6, further comprising:
(5) determining if a domain name is to be deleted; and
(6) acquiring, by the resolution server, the unique identification associated with the domain name to be deleted, and using the unique identification to acquire resolution data shared by the domain names and number of domain names in the domain name group; deleting resolution records of the domain name from a resolution file of the domain name group according to top-level domain suffixes.

10. A service system for implementing domain name registration and resolution based on a domain name group, comprising:
a registration client terminal;
a registration server; and
a resolution server,
wherein the registration client terminal is configured to record information related to domain names, and to transmit the information to the registration server,
wherein the registration server is configured to process registration of a single domain name or to generate a unique identification for a domain name group, to store information related to the domain name group separately, to store registrant information and resolution information associated with the domain names according to the unique identification, and to feed back a processing result to the registration client terminal,
wherein the resolution server is connected to the registration server and is configured to acquire all domain names in the domain name group and resolution data shared by the domain names according to the unique identifications, and to write the domain names and the associated resolution data into resolution files according to top-level domain suffixes respectively.
